(19) United States
(12) Patent Application Publication
(10) Pub. No.: US 2006/0034508 A1
(43) Pub. Date: Feb. 16, 2006

(54) Computer system and method for medical assistance with imaging and genetics information fusion

(76) Inventors: Xiang Sean Zhou, Plainsboro, NJ (US); Lu-yong Wang, New York, NY (US); Dorin Comaniciu, Princeton Jct., NJ (US); David E. Gustafson, North Bend, WA (US); Bill Stewart, Sammamish, WA (US); Sriram Krishnan, Exton, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/143,257

(22) Filed: Jun. 2, 2005

Related U.S. Application Data
(60) Provisional application No. 60/577,526, filed on Jun. 7, 2004.
(60) Provisional application No. 60/606,634, filed on Sep. 2, 2004.

(51) Int. Cl. G06K 9/62

(52) U.S. Cl. 382/156

(57) ABSTRACT

By inputting genetic and imaging information into a trained classification system, a second opinion diagnosis, a prognosis, clinical trial qualification or similar case information are output to assist a user. Consistent analysis may be provided using image based measurements in combination with pharmacogenomics studies. Fusing imaging, genetics and other information, such as clinical data, may more likely reduce the number of uncertainties in medical analysis, possibly improving patient safety, identifying new capabilities and supporting research.

### RELATED APPLICATIONS

The present patent document claims the benefit of the filing dates under 35 U.S.C. § 19(e) of Provisional U.S. Patent Application Ser. No. 60/577,526, filed Jun. 7, 2004, and Provisional U.S. Patent Application Ser. No. 60/606,634, filed Sep. 2, 2004, both of which are hereby incorporated by reference.

### BACKGROUND

The present invention relates to computer based medical assistance. Medical information is input to generate an output for diagnosis, prognosis or characterization.

Pharmacogenomics information may increase the likelihood of proper application of medicine to specific patients. The understanding of molecular basis of individual differences in drug response is a crucial step to optimize drug therapy. The emerging field of personalized healthcare may make use of the individual's molecular profile and biomarkers to assist diagnosis, prognosis and targeted therapy. Understanding of the molecular mechanism of disease may lead to novel target identification, toxico genomic markers to screen compounds, and improve selection of clinical patients.

Genomic analysis of disease may identify molecular entities that require different treatment strategies for optimal outcomes. Therapies directed at the molecular basis of disease may supplant the traditional simple treatment of symptoms of the disease. A pharmacogenomics test and associated personalized healthcare, which predicts therapy response based on a patient's genomic profile, may change the pharmaceutical industry and medicine. Rational drug design may be facilitated by genomics or bioinformatics techniques, such as through the use of molecular predisposition, screening, diagnosis, prognostic, pharmacogenomics and monitoring markers. However, genomics include uncertainties.

### BRIEF SUMMARY

By way of introduction, the preferred embodiments described below include methods, systems and computer readable media with instructions for medical assistance with imaging and genetics information fusion. By inputting genetic and imaging information into a trained classification system, a second opinion diagnosis, a prognosis, clinical trial qualification or similar case information are output to assist a user. Consistent analysis may be provided using image based measurements in combination with pharmacogenomics studies. Fusing imaging, genetics and other information, such as clinical data, may more likely reduce the number of uncertainties in medical analysis, possibly improving patient safety, identifying new capabilities and supporting research.

In a first aspect, a method is provided for medical diagnosis with information fusion. Genetics information is input to a processor. Ultrasound imaging information is also input to the processor. Fused information is determined with the processor as a function of both the input genetics information and the ultrasound imaging information.

In a second aspect, a system is provided for medical diagnosis with information fusion. A memory is operable to store genetics, clinical and medical imaging information. A processor is operable to determine output information as a function of the genetics, clinical and medical imaging information.

In a third aspect, a computer readable storage media has stored therein data representing instructions executable by a programmed processor for medical diagnosis with information fusion. The storage media includes instructions for: receiving genetics and ultrasound imaging information; and outputting diagnosis, prognosis, change quantification or combinations thereof as a function of both the input genetics and the ultrasound imaging information.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for fusing genetics and phenotype information;

FIG. 2 is a flow chart diagram showing one embodiment of a method for fusing genetics and phenotype information;

FIG. 3 is another embodiment of a flow chart of a method for fusing information in personalized healthcare; and

FIG. 4 is yet another embodiment of a flow chart of a method for fusing information for cardiac sudden death.

### DETAILED DESCRIPTION OF THE DRAWINGS AND PRESENTLY PREFERRED EMBODIMENTS

An integrated approach combines phenotype and genotype information for the diagnosis and treatment of cardiovascular or other diseases. Correlating genomic research with well-established methods of clinical practice and research, such as medical imaging, with sophisticated algorithms for automatic medical image understanding may assist in healthcare. Phenotype and genotype evidence ae combined with information fusion and machine learning methods that optimally exploit uncertainties coming from both clinical and genomic fields. Database-guided decision support systems based on heterogeneous information sources (clinical, epidemiological, imaging and genomics/proteomics data) may assist in both diagnosis and treatment. The diagnosis process involves advanced classification algorithms in the presence of phenotype and genotype uncertainties. The treatment involves change quantification problems in longitudinal studies (before and post drug administration) and pharmacogenomics studies for drug development.

In genetics and imaging information fusion for cardiac diagnosis, ultrasound is one imaging modality for assessing the heart function, although magnetic resonance, computed tomography, x-ray, positron emission or nuclear studies may alternatively or additionally be involved. Automatic quantitative tools may enable fast and consistent analysis of echocardiograms, more likely avoiding intra- and inter-observer variability in large clinical studies. Consistent measurements of heart motion, hemodynamics, and morphology may facilitate change quantification in diseases such as coronary heart disease, hypertension, hypertrophy, or arrhythmia. Since genetics information may be more limited currently and since both imaging and genetics have limitations, failures of replication for genetic association studies due to small sample size, bias, and population stratification artifacts may have less affect on outcome using fusion.

FIG. 1 shows a system 10 for medical diagnosis with information fusion. The system 10 includes a processor 12, a memory 14 and a display 16. Additional, different or fewer components may be provided. The system 10 is a personal computer, workstation, medical diagnostic imaging system, network, PACS data management station or other now known or later developed system for automatically classifying medical information with a processor. For example, the system 10 is a medical imaging system with software for genetics association and change quantification. As another example, the system 10 is a computer aided diagnosis system. Automated assistance is provided to a physician for classifying given medical information, such genetics, imaging and/or clinical records of a patient. In one embodiment, assistance is provided for diagnosis of heart diseases or medical conditions, but abnormality diagnosis may be performed for other medical abnormalities, such as associated with the lungs or other organs. The automated assistance is provided after subscription to a third party service, purchase of the system 10, purchase of software or payment of a usage fee.

The memory 14 is a computer readable storage media. Computer readable storage media include various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the instructions are stored on a removable media drive for reading by a medical diagnostic imaging system or a workstation networked with imaging systems. An imaging system or work station uploads the instructions. In another embodiment, the instructions are stored in a remote location for transfer through a computer network or over telephone lines to the imaging system or workstation. In yet other embodiments, the instructions are stored within the imaging system on a hard drive, random access memory, cache memory, buffer, removable media or other device.

The memory 14 has instructions executable by the processor 12 for medical diagnosis with information fusion. In general, the instructions are for receiving genetics and ultrasound imaging information, and for outputting diagnosis, prognosis, change quantification or combinations thereof as a function of both the input genetics and the ultrasound imaging information. The functions, acts or tasks illustrated in the figures or described herein are performed by the programmed processor 12 executing the instructions stored in the memory 14. The functions, acts or tasks are independent of the particular type of instructions set, storage media, processor or processing strategy and may be performed by software, hardware, integrated circuits, film-ware, micro-code and the like, operating alone or in combination.

The memory 14 stores genetics, clinical and medical imaging information. For example, genotype information, gene information, protein information, polymorphisms, haplotypes, combinations thereof or other genetics information discussed herein, now known or later developed are stored. The genetics information is associated with one or more patients and/or tissues of interest, such as heart tissue, blood or both heart tissue and blood.

As another example, an ultrasound image, an x-ray image, a magnetic resonance image, angiography, a computed tomograph image, a positron emission image, a value quantified from an image, combinations thereof or other medical imaging information discussed herein, now known or later developed is stored. The imaging information is associated with one or more patients and/or regions of interest, such as images of a heart or blood flow within a heart. For assessing heart function, ultrasound conveniently provides real-time information for heart function. Using ultrasound images with pharmacogenomics may assist in assessing heart function. The images are for a given time or for different times, such as before and after drug administration.

As yet another example, a patient's treatment, patient history, family history, demographic information, billing code information, symptoms, age, or other indicators of likelihood related to the abnormality detection being performed is stored. For example, whether a patient smokes, is diabetic, is male, has a history of cardiac problems, has high cholesterol, has high HDL, has a high systolic blood pressure or is old may indicate a likelihood of cardiac wall motion abnormality.

The genetics, clinical and medical imaging information are raw data (e.g., an image) or data derived from raw data. For example, medical image information includes a volume, an ejection fraction, a strain, a longitudinal strain, a strain rate, a border, a volume flow, a heart wall thickness, a tissue characteristic, or combinations thereof derived from a medical image. The values are derived from the images by automatic, manual or semi-automatic techniques.

The information is received in the memory 14 from one or more sources. Medical data is input to the processor 12 or the memory 14. The genetics, clinical, imaging or other information may be received through the processor 12, such as where the processor 12 generates the information. The information may be transferred from a remote or local source, such as through a computer network or on removable media. The information may be scanned into the memory 12 or manually entered. The information may be mined from patient records, such as disclosed in U.S. Pat. No. ______ (Published Application No. 20030120458, filed on Nov. 4, 2002, entitled “Patient Data Mining”) or U.S. Pat. No. ______ (Published Application No. 20030120134, filed on Nov. 4, 2002, entitled “Patient Data Mining For Cardiology Screening”), which are incorporated herein by reference. Information is automatically extracted from patient data records, such as both structured and un-structured records. Probability analysis may be performed as part of the extraction for verifying or eliminating any inconsistencies or errors. The system may automatically extract the information to provide missing data in a patient record. The processor 12 performs the extraction of information. Alternatively, other processors perform the extraction and input results, conclusions, probabilities or other data to the processors 12. The different types of information or different information of a same type are from different or the same sources of data.

The processor 12 is a general processor, digital signal processor, application specific integrated circuit, field programmable gate array, analog circuit, digital circuit, combinations thereof or other now known or later developed processor. Any of various processing strategies may be used, such as multi-processing, multi-tasking, parallel processing or the like. The processor 12 is responsive to instructions stored as part of software, hardware, integrated circuits, film-ware, micro-code and the like.

The processor 12 is operable to determine output information as a function of genetics, clinical, medical imaging and/or other information. In one embodiment, the processor 12 implements a model or trained classification system (i.e., the processor is a classifier) programmed with desired thresholds, filters or other indicators of class. For example, recommendations or other procedures provided by a medical institution, association, society or other group are reduced to a set of computer instructions. In response to patient information automatically determined by a processor or input by a user, the classifier implements the recommended procedure for scoring or identifying normal or abnormal states. In an alternative embodiment, the system 10 is implemented using machine learning techniques, such as training a neural network using sets of training data obtained from a database of patient cases with known diagnosis. The system 10 learns to analyze patient data and output a diagnosis. The learning may be an ongoing process or be used to program a filter or other structure implemented by the processor 12 for later existing cases. Any now known or later developed classification schemes may be used, such as cluster analysis, data association, density modeling, probability based model, a graphical model, a boosting base model, a decision tree, a neural network or combinations thereof.

The classifier includes a knowledge base indicating a relationship between the genetics, clinical, medical imaging and/or other information. The knowledge base is learned, such as parameters from machine training, or programmed based on studies or research. The knowledge base may be disease, institution, or user specific, such as including procedures or guidelines implemented by a hospital. The knowledge base may be parameters or software defining a learned model.

The processor 12 generates one or more outputs from the fused information. The output information is a diagnosis, a prognosis, a change quantification or combinations thereof. For example, the output information is a second opinion diagnosis for a patient, a prognosis of a drug interaction for the patient, a change quantification across a group of a plurality of subjects, at least one similar medical record or combinations thereof. Probability or statistical information may also be output. For example, a list of features related to a particular condition are provided with associated probabilities of a current patient and/or fused information satisfying each of the features. A total probability for a particular disease is also output. As another example, a list of possible diseases and the probabilities of a current patient and/or fused information being associated with each of the diseases is output. As yet another example, a patient record or excerpt thereof of a similar or most similar patient is output.

The display 16 is a CRT, monitor, flat panel, LCD, projector, printer or other now known or later developed display device for outputting determined information. For example, the processor 12 causes the display 16 at a local or remote location to display the output information. The output information may also be stored with or separate from the input medical information. An input-to-output approach is used. Alternatively, the processor 12 iteratively interacts with a user for refined analysis in an on-line mode.

The fused information output by the processor 12 may improve patient safety. For example, genetics information for drug interaction in combination with imaging and clinical information for disease diagnosis may indicate risks associated with a particular drug. Imaging, such as ultrasound imaging, may guide genomics research.

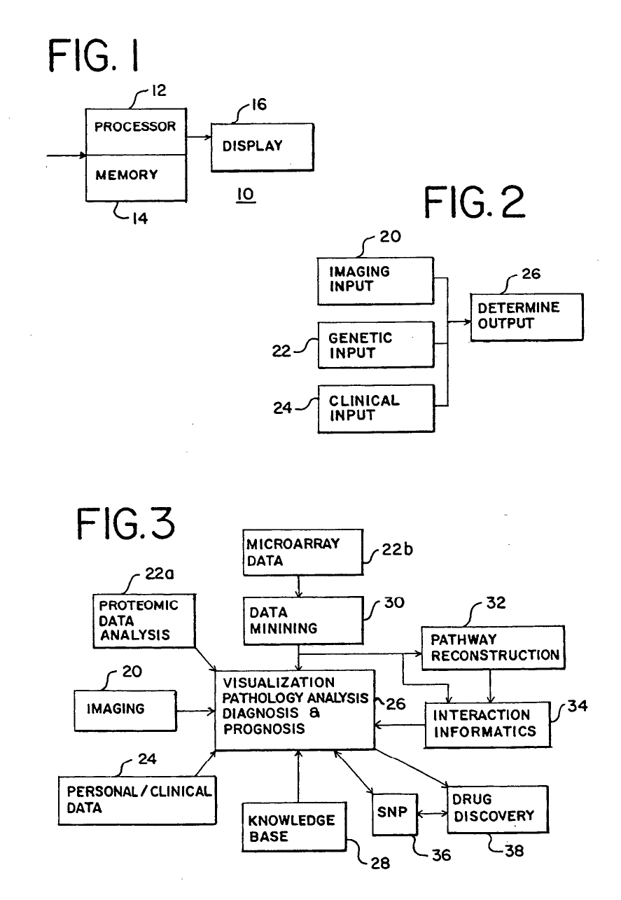

FIGS. 2 and 3 show methods for medical diagnosis with information fusion. Additional, different or fewer acts may be provided. For example, the method is implemented without act 24. As another example, other data sources are input in additional acts. The acts are performed in parallel, in series, in the order shown from left to right or in other orders, such as determining an output in response to one or two types of information before refining the output by later including yet another type of information.

In act 22, genetics information is input to a processor. Genetics information includes genotype, gene, protein or combinations thereof. FIG. 3 shows the genetics information provided separately for proteomic data (22a) and microarray data (22b). Other genetics information discussed herein or now known or later developed may be used. The genetics information associated with heart or other tissue, blood or both tissue and blood. Any one or combinations of the genetics information discussed herein may be input.

In one embodiment, the genetics information is pharmacogenomics data. Pharmacogenomics stems from the fusion of pharmacogenetics with genomics. Genomics introduced a further dimension to personalized medicine, which is enabled by high-throughput technologies, such as microarray and/or proteomics. Determining an individual's unique genetic profile in respect to disease risk and drug response may indicate the pathogenesis of disease. Profiling the expression pattern of genes in a target tissue reveals mechanism of drug in a genomic context and may clarify the inter-individual differences in drug response that are downstream of immediate drug effect in the body.

DNA microarrays in act 22b provide a snapshot of the genome-wide transcription profile. These measurements may fingerprint cellular process, identify transcription factors and their binding regions, identify gene interactions in the transcription process, and identify genomic patterns for classification or relatedness test. Microarrays provide information about the states of transcription in cells and tissues, but additional bioinformatics may provide more accurate indications or information content. Other high-throughput technologies, such as 2D-PAGE, mass spectrometry proteomics technology and/or SAGE, may provide information about the physiological states of the tissues and cells.

Genomic techniques help to identify the new gene targets for drug discovery and to find association between specific genetic markers and drug response in a patient population. Genome-wide searches for genes relevant to disease and/or therapy are used with a map of polymorphism distributed over a genome. Single nucleotide polymorphism (SNP) occurs in a genome. SNP information is input in act 36 for determining the output in act 26. Some SNPs provide relevance to a drug response as indicated by act 38. With SNP maps and high-throughput technology, such as DNA microarray, performing genome-wide association studies during clinical trials is feasible. These high-throughput techniques enable people to identify disease-susceptibility genes for prognosis, drug discovery, and selection of appropriate therapy. If risk for a given disease is predicted to be high, as judged by the SNP pattern of a patient, preventive therapy and lifestyle adjustments may be implemented. A comprehensive SNP map may also contain genetic variants relevant to drug transportation, metabolism, and receptor interaction. Moreover, a comprehensive SNP map may also indicate that careful drug dosage monitoring is required.

Individual changes in nucleotide sequences or SNP may indicate medically significant information. Many common diseases are not caused by one genetic variation within a single gene, but rather are determined by complex interactions among multiple genes, environmental and other factors. Genetic factors confer susceptibility or resistance to a disease and influence the severity or progression of disease. By studying SNP profiles or haplotypes associated with a disease trait, relevant genes associated with a disease are identified and included in the knowledge base 28. Association studies may indicate which pattern is most likely associated with the disease-causing genes. SNP information for polygenic diseases and associated therapeutic targets, SNPs are associated with significant biological effects in response to chemical drugs or other SNP information is input in act 22. For use of the input genetics information, the knowledge base 28 includes associations between SNPs profiling and common polygenic diseases, associations between SNPs and drug response, predicted molecular function changes from structural context of missense mutation produced by cSNP and relation with diseases, and/or SNP haplotyping and relation to diseases.

Proteomic data analysis may provide genetic information input in act 22a. Analysis at organ, sub-cellular, and molecular levels may indicate dynamic, complex and subtle intracellular process in cardiovascular diseases. Proteomics analysis may assist with analysis by providing information at a protein level (e.g., the molecular mechanism underlying cardiovascular disease). Two-dimensional protein polyacrylamide gel electrophoresis (2D-PAGE) is a protein separation technique on the basis of charge and mass of proteins. Spots in the gel represent proteins, and distribution constitutes a fingerprint of any sample. Data extraction from 2D PAGE gels consists of staining, scanning, and then spot detection and quantitative measurement. The proteomic image quality, in terms of spatial and densitometric, may affect accurate spot measurement. Dedicated image processing algorithms may resolve complex overlapping spots and assemble a final spot list. Algorithms follow individual spots through a series of gels (“gel matching”). In protein expression matrix of differentially expressed proteins, different strategies of clustering or classification are utilized according to expression profiles. 2D-PAGE databases are useful to contain digital gel images with links from individual spots to useful annotations, such as HEART-2DPAGE, which contains 2D-PAGE data related to heart development, physiology and disease. Imaging processing, gel matching, protein expression profiling, cluster, classification, and database construction and data mining may be used to input the proteomic genetics information.

Mass spectrometry may determine the mass/charge ratio of ions in vacuum, producing accurate determination of molecular mass. In peptide mass fingerprinting or fragment ion searching, mass spectrometry is used to find correlations in a protein database. A protein sequence can also be determined de novo. Algorithms for database searching may attempt to match the experimentally determined mass of a peptide or peptide fragment to masses predicted from sequence database entries. Alternatively, the amino acid composition of a peptide or peptide fragment is predicted from its mass, then with all permutations as data query. The sequence, database search results, amino acid composition or other data may be input as genetics information.

Proteomics of cardiac muscle and components of the vascular system, including smooth muscle and endothelial cells, may monitor the changes to the cardiovascular systems. In acute conditions, in which there is no adequate time to recruit de novo translation and transcription, posttranslational modification may be the principal mechanism of the change. In chronic conditions or disease state, modification of the proteome often manifests itself as altered protein levels due to specific gene regulation, isoform switching or protein synthesis. Identifying the molecular mechanism of proteome changes and related molecular pathways may be carried out by screening or more focused approaches and input as genetics information. Furthermore, functional proteomics, which incorporate functional biochemical or physiological assays and proteomics, may be input.

Genetics information may, include molecular information. Molecular diagnosis based on gene expression and protein expression fingerprints might differentiate diverse diseases with similar clinical phenotype. A set of molecular biomarkers could determine the prognosis, distinguishing those with an aggressive form and rapid progression of the disease from individuals with slower disease progression, tailing disease respectively. Diseases may be considered heterogeneous, from their causes to rates of progression to their response to drugs. Each person's disease might be special and therefore that person needs to be treated as an individual. As genomics gains knowledge increases and molecular mechanism of disease become even more understood, the disease may be treated based on component parts. Clinical phenotypes may be classified into subclasses by genomic taxonomy. In cardiovascular disease, genetic heterogeneity may indicate long QT syndrome, a disorder of ventricular depolarization. The long QT syndrome seems to originate from mutations in one of at least five different ionic channels (HERG, KVLQT1, SCN5 Å, minK and MiRP1). The clinical cause, level of aggressive therapy and choices of therapy are determined, in part, by the genetic etiology of the syndrome.

As the molecular architecture of disease is determined, medical practice is tailored to properly diagnosis and treatment. The knowledge base 28 and supporting test information is updated to include or be trained with the additional genetics knowledge. Different now known or later developed genetic tests are used to determine genetics information. For example, APOE test among dementia patients may indicate differential diagnosis of Alzheimer's disease. Whole genome association studies may indicate further genetic information of interest by identifying genetic predisposition markers for diseases. RNA and/or protein markers provide further genetic information. DNA variants may predict common, complex diseases that results from a combination of genes and environmental factors. The genetics information is included in a large dataset of gene and protein profiles and proteomics for computational analysis.

Genetics information may be specific to an organ or even disease. For example, genetics information input in act 22 assists in the diagnosis of cardiovascular disease. Drug response of the heart is at least partially under genetic control. Pharmacogenomics is aimed at guild selection of drugs in order to optimize the chance the benefit and minimize the potential for toxicity for individual patients. Understanding the molecular mechanism of cardiovascular disease assists pharmacogenomics understanding. Genomic and proteomic techniques are used to collect genetic information.

The application of microarray experiments in cardiovascular diseases includes: parallel, spatial, and temporal approaches. The parallel approach compares two samples in parallel in microarray experiments on cardiovascular diseases so as to identify the difference in gene expression between two samples representing a test condition and a control condition. For example of abdominal aortic aneurysms (AAA), an increase in nuclear differentiation antigen, cathepsin H, platelet-derived growth factor-A, apolipoprotein E, gelatinase B, matrix metalloproteinase-9, interleukin-8 in abdominal aortic aneurysms and a substantial decrease of myosin light chain kinase may result. AAA patients may exhibit a gene expression pattern indicating chronic inflammation, extra-cellular matrix degradation, arteriosclerosis, smooth muscle cell depletion. The spatial approach identifies differences in gene expression among the different individual cells and the different location, and the temporal approach identifies differences in gene expression among different stages of disease or different time points of treatment.

Analysis of genetic information for cardiovascular analysis may be provided by clustering. A set of objects are partitioned into subsets based on some measure of similarity. The determination of the number of clusters is one of the most difficult problems in cluster analysis. Local shrinking, non-parametric algorithms and other advanced statistical techniques may be applied for microarray analysis. Advanced cluster analysis algorithms of microarrays over time may elucidate gene expression patterns of progressive cardiovascular disease. Periodically expressed transcripts in time-series may be identified and groups in gene expression time-courses inferred. The mechanism of the progression and/or understanding the underlying causes to these diseases may allow use of genetic information for further assistance.

Three dimensional (3D) gene expression patterns in heart may be used. A high-throughput analysis of spatially registered cubes is employed to produce multiple volumetric maps of gene expression analogous to the images reconstructed in biomedical imaging systems. After the normal and disease hearts are dissected into cubes, the cubes are analyzed by microarrays. A gene expression correlation matrix is constructed for both specimens to show an overall picture of the data. Different clustering algorithms may identify spatial expression patterns in the heart. Based on the most correlated genes pairs identified, networks of co-regulated genes and the pathways (metabolic pathways, regulatory pathways, signal transduction pathways, apoptosis pathway, etc) involved may be inferred by TRANSFAC/BLAST and KEGG. Expression patterns in different regions of a heart may be projected into 3D imaging and/or used as input genetics information.

In act 20, ultrasound imaging information is input to the processor. One or more, such as pre and post treatment, ultrasound images are input. Alternatively or additionally, one or more values quantified from at least one ultrasound image are input. For example, a volume, an ejection fraction, a strain, a longitudinal strain, a strain rate, a border, a volume flow, a heart wall thickness, a tissue characteristic, or combinations thereof are input. A waveform representing a value as a function of time or spatial location may be input. A conclusion based on analysis of imaging information may be input. In alternative embodiments, images from one or more different modalities (e.g., MR or CT) are input instead of or in addition to ultrasound images. Other now known, such as disclosed herein, or later developed values or medical image based information may be input.

In one embodiment, the ultrasound images are associated with a heart. Any portion of the heart may be tracked for motion data. For example, the inner heart wall is tracked to determine an amount of contraction, amount of expansion, a difference between maximum and minimum contraction, a difference in the amount of motion between different portions of the heart, a velocity, a timing of the motion, an acceleration or other characteristic of motion of the heart. A global shape or local motion, such as an endocardial wall or epicardial wall, is tracked. The motion is tracked by identifying one or more regions of interest, such as in response to user input or automatic border detection. The same or similar region is identified in a series of images using the minimum sum of absolute differences, correlation, Doppler based-velocity information or other techniques for determining motion parameters of an identified region. In one embodiment, the methods described in U.S. Pat. No. ______ (Ser. No. 10/794,476, filed on Mar. 5, 2003), the disclosure of which is incorporated herein by reference, are used. One or more motion tracking parameters are calculated and input for use in fusion of information for classification.

To determine one or more thickening parameters, the inner and outer borders of the myocardial wall or other portion of the heart are determined. The contours are determined over a time frame, such as during the systole phase, to indicate an amount of wall thickening over the time frame. The thickness is determined at a user indicated region, an automatically detected region or at a plurality of regions. An average or separate parameters may be calculated for each of the plurality of regions. Using the known scan pattern, the distance between the inner and outer wall at the desired regions is determined. Inner and outer boundaries are determined in response to user input or automatically. For automatic determination, automatic border detection may be provided. For example, a gradient associated with a sequence of images is determined to indicate outer and inner wall boundaries through the sequence. Other methods may be used, such as described in U.S. Pat. No. ______ (application Ser. No. 10/794,476), ______ (application Ser. No. 10/991,933), and ______ (application Ser. No. 10/957,380, Publication No. 2005-0074154), the disclosures of which are incorporated herein by reference.

Using the same or different border detection techniques, a volume, a volume change, volume flow, volume ejection fraction or other volume characteristic associated with the heart is determined. For example, the left ventricle volume change between systole and diastole phases is determined. The inner contour of the myocardial wall or other heart boundary is tracked. An area associated with the boundary in a particular view is determined. Where the boundary has gaps, the gaps are filled by curve fitting or a linear connection between closest end points. The area is then converted to a volume using any now known or later developed approximations. Where three-dimensional imaging data is available, the volume may be calculated without approximation or extrapolation.

One or more timing parameters indicate relative motion of different portions of the heart, such as indicating relative motion of the septum and the lateral wall. The difference in onset of motion relative to the heart cycle of two or more locations of the heart indicates a level of asynchrony or dyssynchrony. Differences in total time of motion, onset of motion, completion of motion or other timing events may be used. In one embodiment, the asynchrony calculations or phase information disclosed in U.S. Pat. No. ______ (application Ser. No. 11/051,224), or ______ (application Ser. No. 10/713,453), the disclosures of which are incorporated herein by reference, are used. For example, a sequence of images is analyzed to determine the onset time of periodical motion. Pixel intensity changes in two or three dimensional image sequences are analyzed with a Fourier transform. The relative phases of the first or fundamental harmonic to the heart cycle identifies the onset time of motion for different regions.

Other values or imaging information may be determined, such as disclosed in U.S. Pat. No. ______ (Application Publication No. 2005-0074154). Automatic quantitative tools for assessing cardiac function may enable fast and consistent analysis of echocardiograms.

In act 24, clinical information and/or epidemiological information is input. For automatic determination and input of clinical information, data mining may be used. Clinical information includes the age, lab results, billing codes indicating treatment or diagnosis, prescription information, family information, prior treatment information, symptoms, other diseases, allergies or other medical information for a particular patient.

Data mining may be used for any of the acts 20, 22 or 24. For example, FIG. 3 shows data mining in act 30 from microarray information gathered in act 22b. Relevant information for a particular analysis is mined in act 30 for fusion with other mined or unmined data.

In act 26, fused information is determined with the processor as a function of both the input genetics information and the ultrasound or other imaging information. The output fused information may be determined based on other input information as well, such as determining as a function of the clinical and/or epidemiological information. The information fusion integrates the microarray analysis, biomedical imaging and/or clinical records to refine the early diagnosis, prognosis, and even further drug treatment.

For fusion of different types of information, classification algorithms may provide an algorithm basis for discriminant analysis. Comparative studies involving molecular diagnosis and biomedical imaging-based diagnosis may provide indications of disease. Since many cardiovascular diseases are progressive, association studies between gene expression profiles with different phenotypes during the time courses of disease may provide further assistance. Combining genotyping and phenotyping techniques may assist in understanding disease diversity and progression. Fusion of genetics and imaging may allow for analysis of effects of drug trials during the disease progression. Early diagnosis, even prognosis may be feasible using the fusion of information provided by the algorithms in act 26.

In an integrated functional proteomics and imaging fusion, collaborations related to biochemistry, physiology and pathology of cardiovascular disease train the algorithm and/or create the knowledge base 28. The incorporation of proteomics with existing cardiovascular research framework may allow identifying and characterizing complex protein changes associated with both cardiovascular dysfunction and pharmacological interventions taken in response to dysfunction. Proteomics may facilitate assistance to dissolve molecular mechanism of cardiovascular disease.

The output is determined as a function of a trained classification system. A graphical model (e.g., Bayesian network, factor graphs, or hidden Markov models), a boosting base model, a decision tree, a neural network, combinations thereof or other now known or later developed algorithm or training may be used. Act 26 is performed as a function of a knowledge base 28 stored in a database. The database indicates a relationship between the genetics information and the ultrasound or other imaging information. The classifier is configured or trained for distinguishing between the desired groups of states or to identify options and associated probabilities.

Where some information is not available, the classifier generates fused information or output based on the available information. The lack of data may also be output and/or used to determine associated probabilities.

The output information is a diagnosis, prognosis, change quantification or combinations thereof determined as a function of both the input genetics information and the ultrasound or other imaging information. For example, a diagnosis of a specific patient is determined as a function of the input genetics information and the ultrasound imaging information. By combining phenotype and genotype evidence by using information fusion and machine learning methods, uncertainties from clinical, imaging and genomic/proteomics fields are more likely resolved. Probabilities, similarities with other cases, possibilities or other information representing possible or probable diagnosis given the inputs are output as a second opinion to a diagnosis by a medical professional.

The output diagnosis is provided at a point of care of the patient, such as at a hospital or clinic. The computer system or processor provides a substantially immediate or delayed output to assist diagnosis. Diagnosis guidance based on multiple sources and support systems is provided from database-guided decision support systems based on heterogeneous information sources (e.g., clinical, epidemiological, imaging and genomics/proteomics data). Diagnosis robustness is increased by exploiting both phenotype and genotype uncertainties. The focus is on both diagnosis and treatment. The diagnosis process involves advanced classification algorithms in the presence of phenotype and genotype uncertainties.

The output information may be a prognosis, such as an expected outcome given input or knowledge base 28 actions associated with a drug and a specific patient. The change quantification robustness is increased in longitudinal studies (before and post drug administration) and pharmacogenomics studies for drug development by exploiting both phenotype and genotype uncertainties. The method provides a prognosis system based on various information resources during stages of disease progression. Automatic procedures integrate time series gene expression data with biomedical imaging and medical informatics techniques. The prognosis may provide alternatives and probability information based on the knowledge base 28.

A change quantification across a group of a plurality of subjects is determined as the output information in another embodiment. Automatic analysis quantitative tools for assessment of heart or other function in combination with genomic/proteomic data analysis is used to implement large-scale clinical trials and/or to avoid intra- and inter-observer variability. Consistent measurements of heart motion, hemodynamics, and morphology can facilitate change quantification in diseases such as coronary heart disease, hypertension, hypertrophy, or arrhythmia.

In another embodiment, the output information based on the fusion information is a similar case or cases. At least one similar medical record is identified as a function of the output information. Content-based information-retrieval from genotype/phenotype databases supporting similarity-guided data analysis and personalized diagnosis is provided. Studies that are similar from both phenotype and genotype perspective are retrieved from an integrated phenotype/genotype database (e.g., knowledge base 28) and presented to the system's user for differential diagnosis.

While the methods and systems described above may be used for any conditions, cardiovascular disease case studies are provided below as an example. Heart failure is one of the greatest health problems leading to morbidity in developed countries. The cardiovascular diseases that lead to heart failure are complex. There are many different pathways involved in the transition from compensated cardiac hypertrophy to heart failure.

By identifying pathways or reconstruction of effects in act 32, interaction informatics in act 34 may provide additional information for fusion in act 26. The knowledge base 28 includes the interaction informatics of act 34 or a separate knowledge is used to derive information. The interaction informatics provided additional genetics information derived from the microarray analysis of act 22b or other sources.

In one embodiment, fusion of genetics and imaging information are used for cardiomyopathy analysis. Cardiomyopathy often results in heart failure and is a major indication for cardiac transplantation. Molecular genetics for cardiomyopathies may extend beyond the molecular insights into these specific diseases. Genetically engineered models of human cardiomyopathy mutations bring up the opportunity to define molecules and pathways that participate in cardiac remodeling. Since similar patterns of cardiac remodeling occur in more prevalent, acquired cardiovascular diseases, mechanisms derived from genetic informations may be relevant to a wider range of heart conditions that remodel the heart and contribute to heart failure.

Dilated Cardiomyopathy (DCM) and Hypertrophic Cardiomyopathy (HCM) are two common forms of cardiomyopathy. DCM and HCM result in end-stage heart failure through different remodeling and molecular pathways. DCM is usually characterized by dilated and hypocontractile left ventricle. DCM patients often have easy fatigability, exercise intolerance and right left or/and right heart failure. HCM either occurs sporadically or is inherited as an autosomal dominant pattern with variable penetrance. The left ventricle in HCM is characteristically hypertropic. The diastolic function is often abnormal in spite of the high left ventricle ejection fraction.

Both imaging and genetics information may provide indications of DCM or HCM. From its morphology, dilated cardiomyopathy is a primary heart muscle disease characterized by left ventricular dilatation and impaired contraction of the left ventricle (and occasionally right ventricle) disease. A large number of primary cardiac diseases cause systolic impairment and left ventricular dilatation, which can be diagnosed by two-dimensional echocardiography. Measurements obtained throughout the cardiac cycle provide systolic and diastole dimensions that both index the amount of chamber enlargement and provide an estimate of contractile function, such as with calculations of the fraction of heart muscle shortening and/or the fraction of blood ejected for each beat.

However, for the majority of the patients, no identifiable cause (Idiopathic Dilated Cardiomyopathy, IDC) may be recognized. Molecular diagnosis based on genetics and genomics may reduce uncertainties. The histopathology of IDC is usually nonspecific: degenerating myocytes that exhibit mild-to-moderate hypertrophy without disarray. Some of the idiopathic dilated cardiomyopathy are familial, which can be transmitted as autosomal, X-linked, or mitochondrial traits. The most common mode of inheritance may autosomal dominant. The clinical features of dilated cardiomyopathy resulting from a single gene mutation are considerably heterogeneous. Many loci involved in dilated cardiomyopathy have been identified. Genetic and molecular biology research for some cardiac conditions has provided mechanistic insights into these poorly understood disease processes. A great diversity of genetic causes may exist for dilated cardiomyopathy. As further disease genes are identified, the knowledge base 28 of mutations is updated to assist in computer classification. This genetics information and associated uncertainties is fused with imaging information and associated uncertainties to more likely reach a correct diagnosis or other output.

Some example complex schema of different pathways leading to DCM may be used. In force generation deficits, the sarcomere, which is the basic unit of contraction in muscle cells, produces cardiac muscle contraction by sliding thin and thick myofilaments. Missense mutation in β cardiac myosin heavy chain and in-frame deletion of cardiac troponin T (which is believed to disrupt calcium-sensitive troponin C interactions that are critical for actin-myosin ATPase activity) may cause autosomal dominant dilated cardiomyopathy.

In force transmission deficits, force generated by sarcomere is required to be efficiently transmitted to the extra-cellular matrix in order to maintain physiological heart contractile function. Multiple filamentous proteins, which link contractile apparatus to the sarcolemma, are supposed to function in the propagation of force. Action, which is a force generator, may be linked to cyto-skeletal components that transmit force. Two missense mutations related to action-cytoskeleton interactions may cause dilated cardiomyopathy. Mutations in α-tropomyosin involved in electrostatic interaction with actin or other thin-filament proteins may also cause DCM. Intermediate-filament proteins, such as desmin, precipitate the action to the dystropin-sarcoglycan complex beneath the plasma membrane of muscle cells. Since so many proteins participate in the force transmission processes, deficits in this pathway might be a prevalent cause of dilated cardiomyopathy.

In energy production deficits, mitochondrial fatty acid β-oxidation provides an important source of energy during the fasting. Recessive mutations in genes that encode transport proteins or enzymes involved in cardiac fatty acid β-oxidation may also cause DCM. Defects in this pathway damage the myocardium directly due to the toxic effects of the intracellular accumulation of intermediary metabolites, or indirectly due to inadequate supply of energy. Carnitine provides transport of long-chain fatty acids into mitochondria, and carnitine deficiencies may prevent metabolism of long-chain fatty acids. Mutations in proteins in carnitine transport and metabolism are among heritable causes of dilated cardiomyopathies that are transmitted as recessive traits. Also, mutations in organic cation transporter protein (which transports carnitine into cells), translocase (which shuttles carnitine and acylcarnitine into mitochondria) and carnitine palmitoyltransferase (which catalyzes carnitine derivatives into acyl-CoA) may induce dilated cardiomyopathy. Moreover, there are many DCM-causing mutations, such as Tafazzin, lamin A, lamin C, or cardiac ryanodine, that may assist in classification or identification even though the mechanisms resulting in DCM are unknown.

For acquired dilated cardiomyopathy, similar mechanisms by which single mutations cause dilated cardiomyopathy may also function in non-heritable acquired forms of this disease. For instance, the genetic defect in dystrophin-glycoprotein complex may cause hereditary dilated cardiomyopathy through impairment of force transmission. A similar mechanism may explain the ventricular dilation and dysfunction after viral myocarditis in which enteroviruses encode a protease that can cleave the dystrophin-glycoprotein complex. Since nitric oxide may inhibit a coxsackieviral protease through S-nitrosylation, elucidation of a definitive role of proteases in the pathogenesis of dilated cardiomyopathy may provide more help in the development of novel treatments to prevent the cardiac dysfunction associated with some viral infections and/or identification of disease.

The most common cardiomyopathy may be chronic ischemia that originates from coronary-artery arteriosclerosis. Dilated cardiomyopathy is a progressive disorder that leads to heart failure. Different molecular pathways involved in the DCMs make them more complex and harder to cure. Better understanding of the inciting events and elucidation of myocyte responses triggered are very important to improve quality of life and lengthen the survival of affected individuals. Molecular genetics provide many sources of information and potential benefit for improving and/or identifying the condition.

Different molecular pathways are involved in DCMs. The understanding of different pathways leading DCMs is important to different drug treatment in healthcare. Heart failure resulting from dilated cardiomyopathy appears to develop from different re-modeling and molecular pathways. As the current knowledge base 28 expands, such as analyzing different treatments based on the different mechanisms and employing image-based tools for quantifying the heart function, the fusion of information from multiple sources may further reduce uncertainties.

Microarray techniques provide a genomic approach to explore genetic markers and molecular mechanisms leading to heart failures. The knowledge base 28 may be further increased by: to identify the significantly differentially expressed genes by differential analysis, to identify closely correlated genes at micro-level and to identify co-regulated regions using bioinformatics techniques (e.g., cluster the genes based on correlation coefficient, and get the most correlated pairs, and use TRANSFAC to identify common transcription factor binding region shared), and to map these genes into the different pathways based on Gene Ontology and get functional inference for the different pathways involved. An alternative method is using reverse engineering techniques to reconstruct the pathways. Pathway analysis may provide information to understand the different mechanisms in DCM. Different pathways leading to DCM may result in different drug treatment according to the underlying causes of the disease. Currently known information may alternatively or additionally be used.

Diagnosis of dilated cardiomyopathy is often made through noninvasive cardiac imaging (e.g., echocardiography or ultrasound). However, for some cases, especially at early stages, underlying pathology is not detectable. In addition, for idiopathic DCM, the histopathology tests are not specific. Molecular diagnosis using microarray, although invasive, may alternatively diagnose the DCM as early as possible. The tissue from left ventricular epicardium is analyzed. Microarray analysis, which monitors gene expression level, provides an important tool for molecular diagnosis. Advanced classification algorithms, possibly with refined diagnosis into disease subtypes, are applied to the multiple inputs. Information from different data types (molecular, image, and/or clinical) are used, depending on the uncertainty level provided by each modality. Advanced machine learning techniques may make associations between SNP and disease phenotype or susceptibility to a disease.

It may be difficult to personalize the treatment of each patient due to the high clinical trial expenses implied. However, an optimized drug solution across populations may become feasible by SNP genotyping technology. Based on SNP genotype composition in different populations, it should be possible to treat different patients with appropriate drugs. Clustering based on the genotypes in the SNP databases may be used for computer analysis. For each cluster, a different drug strategy or protocol is developed. A predictive methodology, such as advanced classification algorithms, assigns the patient into a disease subtype and to adapt the treatment according to the patient's SNP composition.

As another example of fusion of information for heart disease, hypertrophic cardiomyopathy information is output. Hypertropic cardiomyopathy (HCM) is a primary disorder of the myocardium. It is characterized by hypertrophy, often in the left ventricle, in the absence of other loading conditions such as hypertension, aortic valve stenosis or thyroid disease. HCMs most serious complication is sudden cardiac death. HCM is the most common cause of sudden cardiac death in individuals no more than 35 years old. Although unexplained cardiac hypertrophy is an important pathologic hallmark of disease, altered cardiac morphology is an age-dependent phenotype, often lacking in children aged less than 10 years.

Familial HCM is a heritable disorder transmitted as an autosomal dominant trait. HCM is a genetically heterogeneous disease with at least 10 causative genes. All these genes encode sarcomere proteins including the cardiac β-myosin heavy chain, cardiac troponin T gene, α-tropomyosin, myosin-binding protein C, cardiac troponin I, essential and regulatory myosin light chain, and the cardiac α-myosin heavy chain, titin and actin genes (see table 2).

TABLE 2
Causal Genes in Hypertrophic Cardiomyopathy

| | | Chromosome | |
|---|---|---|---|
| HCM Gene | Symbol | Locus | % of all HCM |
| β-MHC | MYH7 | 14q12 | 30-35% |
| Myosin-binding protein C | MYBPC3 | 11p11.2 | 20-30% |
| Troponin T | TNNT2 | 1q32 | 10-15% |
| α-tropomyosin | TPM1 | 15q22.1 | <5% |
| Troponin I | TNNI3 | 19q13.4 | <5% |
| Myosin essential light | MYL3 | 3p21 | <1% |
| chains | | | |
| Myosin Regulatory light | MYL2 | 12q24.3 | <1% |
| chains | | | |
| Actin | ACTC | 15q14 | <0.5% |
| Titin | TTN | 2q24.3 | <0.5% |
| α-MHC | MYH6 | 14q12 | <0.5% |

In table 2, MHC means myosin heavy chain, while HCM means hypertrophic cardiomyopathy. The sarcomere, the function unit of contraction in myocyte, is composed of thin and thick filaments. Contraction occurs through sliding between the think and thin filaments. Thick filaments are composed of myosin heavy chain, myosin binding protein C and myosin regulatory thin chains, with which the massive protein titin associates. The thin filament contains actin, the troponin complex (troponin I, T, and C) and tropomyosin. In a normal condition, myofilament slides through the sequential attachment of thick filament myosin and thin filament action, energy-dependent conformational changes in myosin, and then there is action-myosin release. The globular head of myosin heavy chain (“motor in sarcomeres”), which is connected through a flexible region to the rod domain, contains both ATP hydrolysis enzymatic activities and sites for binding actin. As cytosolic calcium rises and binds the troponin complex (composed of subunits C, T, and I) and α-tropomyosin, contraction is initiated. Calcium releases troponin I inhibition of actin-myosin interactions, and actin becomes tightly bound to the myosin head expeditiously. Then, ATP binds myosin and alters the conformation of the actin-binding sites within myosin. That head domain is displaced along the thin filament. Force is generated with ATP hydrolysis and release of ADP and Pi. Force generated by sarcomere is transmitted to the myocyte cytoskeleton through a complex combination of molecules including dystrophin, titin, cardiac myosin binding protein C, and associated sarcoglycan peptides. These provide elasticity to the cell and may also modulate contractile force.

Generally, for dominant gene mutation, some inactivate an allele, resulting in a reduced amount of functional protein (haploinsufficiency), while other dominant gene mutations create a mutant protein that interferes with normal protein function (dominant negative) or has a novel function. Most of the hypertrophic cardiomyopathy mutations are missense mutation or minor truncations that are unlikely to cause haploinsufficiency through either transcript or peptide instability. Structure-function analyses of the location of HCM mutations in sarcomeric proteins indicate that no single common function is perturbed by these mutations. No single function of myosin (such as actin binding, ATP hydrolysis, force transmission, etc) may account for disease. For example, results based on chicken skeletal muscle myosin indicate that mutant myosins have diminished motor activity without changes in enzymatic activity.

Known genetic causes of hypertrophic remodeling (e.g., human mutations in sarcomere protein) or later developed causes may be identified and used for fusing information or resolving uncertainties. Mutations in proteins of the thin and thick filament of the sarcomere, cytoskeletal sarcoglycans, intermediate filament proteins, and nuclear envelope proteins may cause cardiac dilation. Calcium dysregulation may occur in response to gene mutations that trigger cardiac remodeling. As calcium enters the myocyte through L-type (dihydropyridine) calcium receptors to activate ryanodine receptors (RyR), calcium-induced calcium release (CICR) is triggered. Elevated calcium activates sarcomere contraction. Calcium ATPase pump (SERCA), which is regulated by phospholamban (PLN), is activated. Activated SERCA removes calcium from the cytoplasm and restores sarcoplasmic reticulum levels. Calcium-binding proteins contained in sarcoplasmic reticulum may activate genetic programs of cardiac hypertrophy and dilation.

The genetic mechanisms leading to HCM are partially understood, so the knowledge base 28 may be increased through future understanding. Further microarray analysis and proteomic analysis of the HCM cardiac cells of human and model animals to determine what signaling pathways lead HCM gene defect to clinical phenotypes, how this process is modified by either genetic and or environmental factors, e.g., exercise, diet, drug treatment, etc. and what are genetic programs (gene expression regulations, various pathways) of cardiac hypertrophy may identify additional information to use in the knowledge base 28.

For analysis by fusing information, initial diagnosis of hypertrophic cardiomyopathy is often done through echocardiography. Since altered cardiac morphology is an age-dependent phenotype, often lacking in children aged less than 10 years, molecular diagnosis using microarray or proteomics techniques may avoid or reduce uncertainties, especially for children. The molecular profiling “fingerprints” associated with advanced imaging analysis techniques are fused to combine various evidences for more reliable diagnosis. Additionally, SNP association analysis and/or SNP clustering for personalized healthcare may benefit analysis.

As another example of fusion of information for heart disease, ischemic heart disease information is output or analyzed. Ischemic heart disease is a disorder that affects the supply of blood to the heart. As the cholesterol plaques are deposited on blood vessel walls, blood vessels are narrowed or blocked. This process reduces the supply of oxygen and nutrients to the heart muscles, which is essential for proper functioning of the heart. This may eventually result in a portion of the heart being deprived of its blood supply leading to the death of that area of heart tissue and causing heart attacks.

The biochemical and cellular pathology associated with cardiac dysfunction has been characterized, such as in different animal models. Susceptibility mutations for ischemia can be found in genes affecting development of atherosclerosis through conventional cardiovascular risk factors, genes affecting development of atherosclerosis through other mechanisms or in genes affecting blood coagulation precipitating in a myocardial infarction in individuals with pre-existing atherosclerosis. Susceptibility mutations, including mutations in apolipoprotein B, lipoprotein lipase, and angiotension converting enzyme (ACE) genes influencing plasma levels of cholesterol, triglycerides and ACE activity, may indicate ischemia, but may indicate with uncertainty.

Myocardial ischemia and reperfusion leads to cell death. This process is accomplished through apoptosis. Apoptosis is cell-autonomous mechanism to eliminate injured or unwanted cells without inducing an inflammatory response. The signal transduction pathways leading to apoptosis may involve the JNK pathway, ceramide generation and inhibition of protective PKC pathways.

Gene expression analysis of a small number of genes in a defined physiological condition or more complex analysis may be used to provide genetic information. Gene expression information directed at a specific cellular pathway or stress response, the renin-angiotensin system, apoptosis, ion channels, transcription factors, heat shock proteins, and anti-oxidant enzymes may be used. Modern genomic and proteomic techniques, such as microarray, provide useful tools for profiling gene expression in a large scale.

For reversible ischemia, which is caused by one or several brief transient episodes of complete coronary occlusion or a more prolonged but partial coronary ligation, many up-regulated genes are involved in the “cell survival program”. On the other hand, permanent coronary occlusion lasting from one day to several weeks results in a true myocardial infarction. In this case; up-regulated genes include those related to remodeling (for example, laminin, collagens I and III, fibronectin) and apoptosis (Bax); whereas many down-regulated genes are related to major energy-generating pathways, fatty acid metabolism, in the heart. Gene expression profiling may provide information for a protective program activated upon brief episodes of transient ischemia and an injury-related one activated in response to irreversible lethal ischemic injury. Identification of factors and mechanisms involved in turning on protective genes and/or turning down injury-related ones may provide further therapeutic strategies for treating ischemia. As further genetic information is identified, such as what are the particular roles of up-regulated genes and down-regulated genes in different setting of ischemia, what are the related biological pathways involved, what are the mechanisms leading to ischemia, what is the relationship between transient and irreversible ischemic injury, what are the factors turning on protective genes and turning down injury-related ones, or vice-versa, what are the time-events in gene expression changes involved in the progression of ischemia, what is the mechanism of the disease, are cardiovascular diseases such as ischemia gene-decisive or proteome-related, and what roles of post-translational modification play in ischemia, the knowledge base 28 is increased or altered for analysis.

As another example of fusion of information for heart disease, long-QT syndrome information is output or analyzed. Sudden cardiac death is a significant problem. The underlying cause of death is commonly considered to be primary or secondary arrhythmias. For young people, who have no identified structural heart disease, long-QT syndrome is one possible cause. In long QT syndrome, the duration of repolarization is longer than normal. The QT-interval is prolonged. An interval above 440 msec is considered prolonged. QT-prolongation is due to overload of myocardial cells with positively charged ions during ventricular repolarization. The long QT syndrome causes an abnormality of the heart's electrical system. The mechanical function of the heart may be entirely normal. The electrical problem is due to defects in ion channels.

A growing number of drugs associated with QT prolongation and its concomitant risks of arrhythmia and sudden death have been shown to block the rapid cardiac delayed rectifier potassium current (I_{Kr}) or cloned channels encoded by gene HERG which is believed to encode native I_{Kr}. Because I_{Kr} plays an important role in ventricular AP repolarization, its inhibition may result in prolongation of both the AP and QT interval of the electrocardiogram. Multiple genes causing long QT syndrome have been identified and encode cardiac ion channels. They are two potassium channel α subunits (KVLQT1 and HERG), two potassium channel β subunits (minK and MiRP1) and one sodium channel gene (SCN5A). Using now known information or later developed information, such as structural modeling of the long QT syndrome ionic channels to elucidated the pathology of the disease, computational screening for potential drugs as candidate treatment for long QT syndrome and/or association study between SNP and long QT disease, a fusion-based analysis is provided for cardiac sudden death.

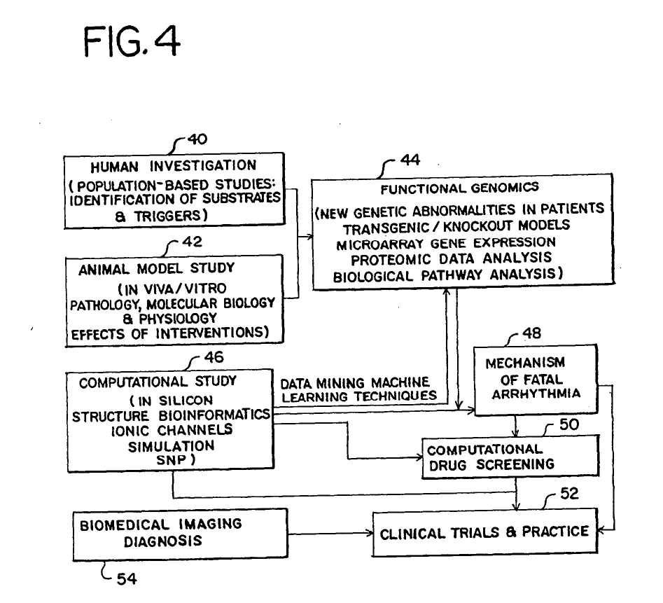

FIG. 4 shows one embodiment of fusion of information for computer assisted analysis of sudden cardiac death potential. Human investigations (e.g., population based studies and/or identification of substrates and triggers of sudden cardiac death) in act 40 are combined with animal model studies (e.g., in vivo or vitro pathology, molecular biology, and/or physiology effects of interventions) in act 42. In act 44, the knowledge base related to functional genomics information is formed from the information of acts 40 and 42. Genetic abnormalities in patients, transgenic or knockout models, microarray gene expression, proteomic data analysis and/or biological pathway analysis information are gathered for computer processing. In act 46, computational study or analysis with structured bioinformatics, ionic channels, simulation and/or SNP analysis are performed. The computations study may output derived genetics information. Using any known mechanism of fatal arrhythmia in act 48, the genetics information is input for computational drug screening in act 50, clinical trails and practice of act 52 or other analysis system. In acts 50 and/or 52, the genetics information is used to develop output information. Imaging information is provided in act 54. By fusing the imaging information of act 54 with the genetics information of acts 40, 42, 44, 46 or 48, the clinical trails and practice act 52, the computational drug screening act 50 or other computer assisted analysis may more likely resolve uncertainties.

To the extent current understanding of a disease from a genetics or phenotype basis is incorrect, the knowledge base 28 is altered. The classifier may be retrained. Different information may be input for classification.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I(We) claim:

1. A method for medical diagnosis with information fusion, the method comprising:
inputting genetics information to a processor;
inputting imaging information to the processor; and
determining fused information with the processor as a function of both the input genetics information and the imaging information.

2. The method of claim 1 wherein inputting genetics information comprises inputting genotype information.

3. The method of claim 1 wherein inputting genetics information comprises inputting gene information, protein information or both gene and protein information.

4. The method of claim 1 wherein inputting genetics information comprise the genetics information associated with heart tissue, blood or both heart tissue and blood.

5. The method of claim 1 wherein inputting imaging information comprises inputting one or more ultrasound images.

6. The method of claim 1 wherein inputting imaging information comprises inputting one or more values quantified from at least one ultrasound image.

7. The method of claim 6 wherein inputting the one or more values comprises inputting a volume, an ejection fraction, a strain, a longitudinal strain, a strain rate, a border, a volume flow, a heart wall thickness, a tissue characteristic, or combinations thereof.

8. The method of claim 1 wherein determining the fused information comprises determining as a function of a trained classification system.

9. The method of claim 8 wherein determining the fused information comprises determining with a graphical model, a boosting base model, a decision tree, a neural network or combinations thereof.

10. The method of claim 8 wherein determining comprises determining as a function of a knowledge base stored in a database indicating a relationship between the genetics information and the imaging information.

11. The method of claim 1 wherein determining the fused information comprises determining an output of a diagnosis, prognosis, change quantification or combinations thereof as a function of both the input genetics information and the imaging information.

12. The method of claim 11 wherein determining the output comprises determining the diagnosis as a function of the input genetics information and the imaging information for a specific patient; and
further comprising:
outputting the diagnosis at a point of care of the specific patient

13. The method of claim 11 wherein determining comprises determining the prognosis associated with a drug and a specific patient.

14. The method of claim 11 wherein determining comprises determining a change quantification across a group of a plurality of subjects.

15. The method of claim 11 wherein determining comprises determining for a specific patient; and
further comprising:
identifying at least one similar medical record as a function of the output.

16. The method of claim 1 further comprising:
inputting clinical information and epidemiological information;
wherein determining comprises determining as a function of the clinical and epidemiological information.

17. A system for medical diagnosis with information fusion, the system comprising:
a memory operable to store genetics, clinical and medical imaging information; and
a processor operable to determine output information as a function of the genetics, clinical and medical imaging information.

18. The system of claim 17 wherein the genetics information comprises genotype information, gene information, protein information or combinations thereof, and wherein the medical imaging information comprises an ultrasound image, an x-ray image, a magnetic resonance image, a computed tomograph image, a positron emission image, a value quantified from an image or combinations thereof.

19. The system of claim 17 wherein the genetics information is associated with heart tissue, blood or both heart tissue and blood, and wherein the medical image information is a volume, an ejection fraction, a strain, a longitudinal strain, a strain rate, a border, a volume flow, a heart wall thickness, a tissue characteristic, or combinations thereof.

20. The system of claim 17 wherein the processor is a trained classification system.

21. The system of claim 20 wherein the trained classification system is a graphical model, a boosting base model, a decision tree, a neural network or combinations thereof.

22. The system of claim 20 wherein the trained classification system includes a knowledge base indicating a relationship between the genetics, clinical, and medical imaging information.

23. The system of claim 17 wherein the output information is a diagnosis, a prognosis, a change quantification or combinations thereof.

24. The system of claim 17 wherein the output information is a second opinion diagnosis for a patient, a prognosis of a drug interaction for the patient, a change quantification across a group of a plurality of subjects, at least one similar medical record or combinations thereof.

25. In a computer readable storage media having stored therein data representing instructions executable by a programmed processor for medical diagnosis with information fusion, the storage media comprising instructions for:
receiving genetics and ultrasound imaging information; and
outputting diagnosis, prognosis, change quantification or combinations thereof as a function of both the input genetics and the ultrasound imaging information.

26. The instructions of claim 25 wherein receiving genetics information comprises receiving genotype information, gene information, protein information or combinations thereof, and wherein receiving ultrasound imaging information comprises receiving an ultrasound image, a value quantified from at least one ultrasound image, a border or combinations thereof.

27. The instructions of claim 25 wherein receiving genetics information comprises receiving genetics information associated with heart tissue, blood or both heart tissue and blood, and wherein receiving the ultrasound imaging information comprises receiving a volume, an ejection fraction, a strain, a longitudinal strain, a strain rate, a border, a volume flow, a heart wall thickness, a tissue characteristic, or combinations thereof.

28. The instructions of claim 25 wherein outputting comprises determining the diagnosis, prognosis, change quantification or combinations thereof as a function of a trained classifier.

29. The instructions of claim 28 wherein determining comprises determining with a graphical model, a boosting base model, a decision tree, a neural network or combinations thereof.

30. The instructions of claim 28 wherein determining comprises determining as a function of a knowledge base stored in a database indicating a relationship between the genetics information and the ultrasound imaging information.

31. The instructions of claim 25 wherein outputting comprises outputting a second opinion diagnosis for a patient, a prognosis of a drug interaction for the patient, a change quantification across a group of a plurality of subjects, at least one similar medical record or combinations thereof.
